(19) United States
(12) Patent Application Publication
(10) Pub. No.: US 2002/0195498 A1
(43) Pub. Date: Dec. 26, 2002

(54) Method and device for preventing uncontrolled and unauthorized use of credit cards and like data devices

(76) Inventor: Joseph John Cozzolino, Belleville, NJ (US)

Correspondence Address: Joseph J. Cozzolino, 233 Linden Ave, Belleville, NJ, 07109, US

(21) Appl. No.: 09/886,435

(22) Filed: Jun. 21, 2001

(51) Int. Cl. G06K 19/00

(52) U.S. Cl. 235/487

(57) ABSTRACT

An authorization card, such as a credit card, has a pro-active security feature. The authorization card has a limit-access credit code number prominently displayed on its face or front. The first half of the code number indicates the maximum amount of credit available for a specific time period. The last half of the number indicates the maximum amount of credit available on the authorization card. This pro-active feature of the authorization card finally allows the issuers of authorization cards to take the offense in fighting fraud, theft and other illegal activities in regard to authorization cards rather than defensive approaches to this problem which were the only methods available to them prior to this invention. This pro-active security feature can be implemented on magnetic cards, smart cards and other cards of this nature.

### BACKGROUND OF INVENTION

The present invention relates to a method and device for preventing uncontrolled and unauthorized use of credit cards, bank cards or the like which serves as a pro-active security feature. For purposes of this application, these cards will be generally referenced as “AUTHORIZATION CARDS”. The device comes in the form of a limit-access credit code number prominently displayed on the front or face of authorization cards.

Authorization cards are generally magnetic or electronic “smart cards”. For magnetic cards, confidential information particular to the rightful card owner is typically stored in a magnetic strip located on the back side of the card. In order to complete a given transaction, the confidential information stored on the card is directly transmitted from the magnetic strip to a card reader for recognition authorization.

Present day authorization cards can cause both the users and credit card issuers severe economic damage. Defensive safety programs proposed and used to date are not sufficiently effective in preventing misuse, over use and fraudulent use of these cards. However, the pro-active security feature of this invention will automatically and strictly limit access to credit on the card if it is stolen or lost.It will also restrict authorized users to predetermined credit limits for specific time periods. This feature is not available with authorization cards currently in use.

Authorization cards are currently being produced without controlled time and spending limits, making it extremely difficult for card issuers to control fraud and theft. This common oversight in authorization cards allows for only defensive measures to combat fraud,theft and other illegal activities and uses, with the exception of uncontrolled use, which this invention specifically addresses. These defensive measures are complicated, costly and ineffective in preventing uncontrolled use whether by authorized or unauthorized users. Fraudulent and uncontrolled use of authorization cards has cost users and issuers(such as visa, mastercard, american express and discover) as well as entities that accept credit cards as a form of payment for goods and services, a great deal of money.

### SUMMARY OF INVENTION

The main characteristic feature of the new device is a prominently displayed limit-access credit code number on the face or front of the authorization card which limits and prevents uncontrolled use, mis-use, compulsive use and fraudulent use whether in the hands of authorized users or unauthorized users. This is possible because the pro-active nature of the code number works automatically and the verification process is through a simple visual inspection. The fact that the card's time and credit limits are displayed as such creates an automatic deterrent to unauthorized users who are compulsive and over users of credit.

The main feature of the present invention addresses inherent flaws in current cards and was designed to protect user from over indulgent use. Said design also makes fraudulent use and theft not profitable and very difficult to accomplish.

Users of current credit cards could conceivably use up their entire credit limit at one time. If a credit card were to get into the hands of an unauthorized user, this user could instantaneously access the entire credit limit of said card. This leaves both the original owner and card issuer at great risk for loss which unfortunately is the current state of affairs with current credit cards.

The issuers of credit cards have no way to limit losses, in a pro-active way, on current credit cards. Their exposure is the entire credit limit associated with a given card. If a credit card has a limit of $5000, the exposure is $5000. If the limit is $25,000, the exposure is $25,000. This is the major weakness and flaw with credit cards in circulation today.

Credit card misuse and over use is an addiction just like any other addiction and many users should be protected from themselves.

The current shortcomings of the credit card industry have not addressed the misuse of credit cards. That is, they have not figured out how to restrict users from misuse, uncontrolled use and un-restricted spending.

It is the primary object of the present invention to provide an authorization card that prevents uncontrolled use and prevents unauthorized users from accessing the maximum allowable credit limit at one time.

It is another object of the invention to provide a pro-active security feature for a card having confidential information stored on either a magnetic strip or semi-conductor chip.

It is a further object of the invention to provide an authorization card which physically appears valid and readily accessable, though in actuality, through its “limit-access” credit code number, access to the maximum credit limit is greatly restricted.

It is yet another object of the invention to provide a secured authorization card that incorporates a visual feature which allows entities that accept credit cards as a form of payment for goods and services to instantaneously know if intended use is valid or fraudulent. This visual feature also protects the authorized user from over indulgent use.

The pro-active nature of this solution to authorization card misuse, fraud and theft makes the present invention extremely easy and effective in combating the ongoing problems associated with authorization cards and their numerous applications and uses.

The pro-active security feature built into and displayed on the present invention enables entities, that accept credit cards as a form of payment for goods and services, to immediately know whether the credit they are advancing is legitimate versus the problem with the current system where issuers extend credit only to find out after the fact that they shouldn't have.

Because of the unique pro-active feature of the present invention, pertinent information about certain aspects of it can be open and public without any negative consequences or loss of effectiveness against fraud, abuse and theft. In fact, the very nature of this information being so visable provides it with security features that make it more effective in fighting uncontrolled use than the more sophisticated cards currently in use.

### BRIEF DESCRIPTION OF THE PREFERRED EMBODIMENT

Various embodiments of the device according to the present invention will be described in more detail below, reference being made to the accompanying drawings in which:

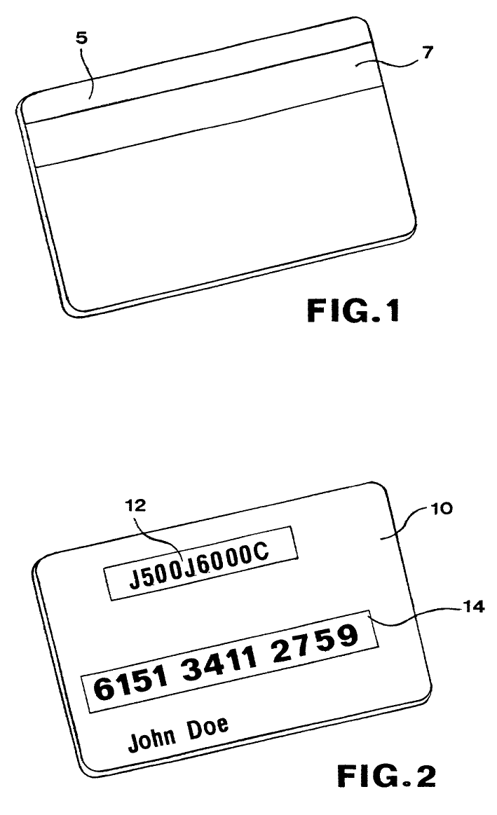

FIG. 1 shows a perspective view from above which shows the back side of a credit card and the likes referenced as “AUTHORIZATION CARDS” with a standard magnetic strip magnified.

FIG. 2 is a perspective view showing the main embodiment of the card which is the limit-access credit code number on the face or front of the present invention. This main embodiment is comprised of two secondary embodiments which when combined create this main embodiment.

### DESCRIPTION OF THE PREFERRED EMBODIMENT

In describing preferred embodiments of the invention illustrated in the drawings, specific terminology will be used for sake of clarity. However, the invention is not intended to be limited to the specific terms used, and it should be understood that specific terms include all technical equivalents which operate in a similar manner to accomplish similar purposes.

The present invention is an authorization card having a security feature to prevent unauthorized use of the card. The pro-active nature of the card allows it to be readily accessable at all times. A prominently placed limit-access credit code number on the face of the card enables merchants and other entities that accept credit cards as a form of payment for goods and services to instantly know the credit limits available for a specific card.

The security feature is preferably implemented on magnetic cards but not necessarily limited to these uses.

As is the requirement that authorization cards, to be used, must be verified using standard procedures or activated by using a conventional card reader (not shown), portable auxiliary devices or through other suitable means, a card utilizing present invention can use this existing technology in the same manner. However, the open nature of the pro-active, offensive security feature of the invention enables it to be used freely without the constraints of complicated security features that must be incorporated into other authorization cards as defensive mechanisms to curtail credit card fraud and theft related activities. Consequently, although this invention uses existing authorization card technology the only addition is a prominently displayed limit-access credit code number on the front of the card. This simple pro-active feature makes this invention more secure from fraud and theft than cards which incorporate sophisticated electronic devices and other complicated electronic defensive methods to accomplish similar objectives with less success.

Now turning to the drawings. FIG. 1 shows an authorization card 5 having a typical magnetic strip 7, as preferably implemented for use as a credit card. The magnetic strip 7, when activated, can be read on a conventional card reader (not shown). The magnetic strip 7 conforms to international standards for credit or bank cards.

Now turning to FIG. 2.It shows the front of the authorization card 10.The pro-active limit-access credit code number 12 is prominently located and displayed.This number varies for various batches of cards that correlate to the amount of credit available. The pro-active limit-access credit code number 12, shows that this card will allow its user to use up to $500 during any monthly period with a credit limit maximum on this card of $6000. Thus this number is depicted as J500J6000C. A card with a $200 monthly limit and a credit limit maximum of $2400 would be displayed as J200J2400C. A card with an $800 monthly limit and a credit limit maximum of $9600 would be displayed as J800J9600C.

Notice that in these examples the monthly credit limit is one-twelfth of the maximum credit limit available for a particular card.

Typical standard credit card identification numbers common to all authorization cards are placed on all cards as illustrated by number 14 in FIG. 2.

The limit-access credit code number is a alpha-numeric number. It is set up in such a fashion as to make it an extremely pro-active method and device to effectively reduce uncontrolled credit use, fraud and theft. It accomplishes this without the use of complicated and sophisticated electronic security control devices currently being used by credit card issuers in an attempt to reduce the costly consequences of these problems.

For illustrative purposes we begin the limit-access credit code number with an alphabetical symbol. Next comes a numerical number which will represent the maximum amount of credit that will be available within a limited time period. For this description we will use the time period of one month. Next comes another alphabetical symbol. This second alphabetical symbol separates the first number described above from a second set of numerical numbers which will represent the maximum credit available for a specific card. Following this second set of numbers comes another alphabetical symbol.A typical illustration of how this number may appear is as follows: J500J6000C.

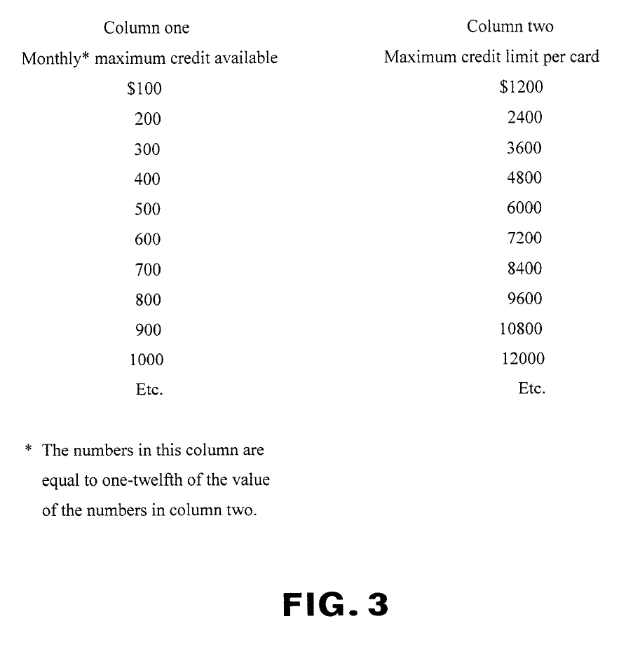

FIG. 3 shows a chart with two columns. The first column shows a series of various monthly maximum credit limits. The second column shows the maximum credit limit available per card corresponding to the monthly amount in column one. Therefore, according to the amount of credit being given, an authorization card will be imprinted with the numbers from both columns corresponding to both these numbers joined but separated by the alphabetical symbols as mentioned above.

Referring back to the number J500J6000C, this number, prominently displayed on the front or face of an authorization card, means that the first portion of the numerical number (500) preceded by an alphabetical symbol, indicates that this card has a maximum monthly credit limit of $500 available for any specific monthly period. The second number (6000) which is separated from the first number by a second alphabetical symbol means that the maximum credit available on this specific card is $6000. The three alphabetical symbols, the “J” at the beginning, the second “J” which separates the monthly maximum (first numerical number) from the maximum credit available for the card (second numerical number) and the “C” at the end of the number have no significance to this number except to separate the two numbers from each other. The non-significance of the three alphabetical symbols do not diminish the effectiveness of the security feature of this limit-access credit code number. However, at the discretion of the credit card issuer, this number can be made even more effective and fraud proof if these arbitrary and non-significant alphabetical symbols were replaced with the initials of the person who will become the authorized user of the card. This can be done as an option by the credit card issuer.

This limit-access credit code number can have many variations consisting of various alphabetical and numerical code numbers as long as the monthly credit limit and maximum credit limit are displayed as described above.

This prominently displayed number allows both the authorized user and the issuer of credit to immediately know what the credit limit of any particular card is at any given time without doing any extra security checks except for a visual inspection of the card.

This pro-active way to check for credit worthiness and fraud is both simple and effective and a much better method to prevent uncontrolled use, fraud and theft than the more costly and cumbersome methods of dealing with this ever growing problem of credit card fraud and abuse.

A typical scenario illustrating how an issuer of credit can immediately determine if a user of a card is the authorized user, when using this invention can be illustrated as follows:

Lets assume the above described limit-access credit code number (J500J6000C) is on a card that is stolen. The new user attempts to purchase an item whose cost is greater than the maximum monthly credit available for this card. When the issuer of the credit visually inspects the limit-access credit code number, he or she will instantly recognize that the current holder of the card is attempting to make a purchase with this card that is greater than its monthly limit. This will immediately warn the credit issuer that this particular user of the card may not be the legitimate owner because the legitimate owner would not normally attempt to spend above the monthly credit limit allocated for the card.

This card will do much to curtail credit card fraud and abuse and do so in such a simple cost effective way for all parties involved.

The pro-active security feature of the present invention provides the following advantages over existing authorization cards:

(a) It limits the amount of funds that can be used to a specific amount within a given window of time.

(b) Monthly credit limits can be set for specific users.

(c) It restrains compulsive users from over use and over indulgence.

(d) It helps credit card issuers to control and limit their losses.

(e) It helps more people to qualify for credit because of the controlled access and loss prevention features.

(f) It drastically reduces fraud and theft. If stolen or illegally used, only a small amount of the total available credit would be at risk versus 100% exposure on existing authorization cards.

(g) It provides parents with a tool that allows them to indirectly control and monitor the amount of credit their children will have access to and be able to use during any specific time period.

(h) It allows business owners to have advance knowledge of the maximum amount of credit that can be used by their employees who have company authorization cards.

(i) It can automatically reduce fraud (theft of money by 80% or more) based solely on its pro-active limit-access credit code number.

(j) It will make theft of this invention not as attractive and profitable as it is with existing authorization cards.

(k) If stolen, it will not allow fraudulent user to easily exploit it as is the case with current cards and the maximum loss would be less than 20% as compared to 100% with current authorization cards.

(L) It helps compulsive users of credit, control their out of control spending habits.

The preceeding descriptions and drawings should be considered as illustrative of the principles of the invention.

The invention may be used in a variety of applications and is not limited only to authorization cards. Likewise, the limit-access credit code number is not limited to the alphanumeric number as described above. Numerous applications of the present invention will readily occur to those skilled in the art. For example, although the invention has been described for use in a credit card application, it is recognized that the feature may be implemented in devices that store confidential information in a variety of sizes, shapes and ways. Therefore, it is not desired to limit the invention to the specific examples disclosed or the exact construction or operation as shown and described. Rather, all suitable modifications and equivalents may be resorted to, falling within the scope of the invention.

The operation of the invention is similar to using a standard authorization card with the exception being the pro-active built in safety feature which protects both the user and credit issuer by controlling and limiting access and use to both authorized users and unauthorized users.

Credit card issuers are becoming more sophisticated in trying to control unauthorized use of credit cards but their approach has always been defensive in nature and in the process of using this approach they must resort to very complicated measures to accomplish their objectives. Because of these ever increasing precautions it is becoming ever more complicated to perform credit card transactions. Even so, they still have not successfully addressed the problem of uncontrolled use of credit cards.

The novelty of my method and device for controlling uncontrolled spending,fraud and theft lies in the simplicity and power of the prominent placement of the limit-access credit code number on the front or face of the authorization card. This was purposely done so that the authorized user and any issuer of credit will always know the maximum amount of credit that can be accessed and approved at any one time within a specific time limit.

Accordingly, the reader will determine that the special built in limits of this invention will do much to help the credit card industry, including end users, the card issuers and all associated with it. In addition, with the built in controls, more people will feel comfortable in using this invention and in turn will expand the revenue base for card issuers. Also, built in control mechanisms will allow more people to qualify for credit using this invention.

Although the descriptions above contain many specificities, these should not be construed as limiting the scope of the invention but as merely providing illustrations of some of the presently preferred embodiments of this invention.

I claim:

1. A method for limiting and controlling access to credit comprising a prominently displayed “LIMIT-ACCESS CREDIT CODE NUMBER” ON AUTHORIZATION CARDS.
